(19) United States
(12) Patent Application Publication
(10) Pub. No.: US 2009/0266138 A1
(43) Pub. Date: Oct. 29, 2009

(54) Method and Apparatus for Shear Strain Testing of Strain Sensors

(75) Inventors: Graham McDearmon, North Canton, OH (US); Brent Mathie, Louisville, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The Timken Company, Canton, OH (US)

(21) Appl. No.: 12/301,643

(22) PCT Filed: Jun. 7, 2007
(86) PCT No.: PCT/US07/70574

§ 371 Date: Nov. 20, 2008

(51) Int. Cl. G01N 3/62; G01N 3/24; G01L 25/00

(52) U.S. Cl. 73/1.15; 73/841

(57) ABSTRACT

A method and apparatus for testing, evaluating, and/or calibrating strain sensors. A test beam (12) having a uniform shear-strain region is secured at opposite ends of a longitudinal axis by uniform force clamp assemblies (14) and (16). A first clamp assembly (14) at one end of the rectilinear test beam is configured to hold the rectilinear test beam (12) in a fixed position, while the second clamp assembly (16) at the opposite end is configured to enable application of torque to the test beam (12) about the longitudinal axis. Displacement sensors (60) in operative proximity to the second clamp assembly (16) provide data which is representative of the deflection of the test beam (12) about the longitudinal axis in response to the applied torque, while a torque sensor (62) provides data which is representative of the actual applied torque. Output signals from one or more strain sensors (64) disposed on the surface of the rectilinear test beam (12), within the region of substantially uniform shear-strain, may be tested and/or calibrated in relation to the deflection of the rectilinear test beam (12), the applied torque, and optionally to an environmental condition such as temperature.

### CROSS-REFERENCE TO RELATED APPLICATIONS

This application claims priority to U.S. Provisional Application No. 60/804,296 filed Jun. 9, 2006 entitled METHOD AND APPARATUS FOR SHEAR STRAIN TESTING OF STRAIN SENSORS and which is incorporated herein by reference.

### BACKGROUND ART

The present invention is related generally to testing and calibration procedures, and in particular, towards a method and an apparatus for the testing and calibration of the response of strain sensors to applied shear strains at various temperatures, as well as the measuring of material response to applied shear strains at various temperatures.

When testing and/or calibrating a sensor, it is necessary to conduct the procedures in a controlled environment to avoid the introduction of unknown environmental variables into the test process. When testing and/or calibrating strain sensors, it is important that the testing and/or calibration procedures have a high degree of repeatability. Furthermore, when testing and/or calibrating multiple sensors simultaneously or in sequence, it is necessary for each sensor to be subjected to substantially the same operating conditions.

Strain sensors are designed to provide an output signal which is representative of the shear-strain forces acting on the body to which the strain sensors are secured, and specifically, to the shear-strain forces in proximity to the mounting location of the strain sensors on the body. Sensors disposed at different locations about a body may experience different levels of shear-strain forces in response to an applied force on the body, depending upon the configuration of the body itself. Accordingly, it is difficult to obtain repeatable measurements of shear-strain forces acting on a body with a strain sensor if the sensor is repeatedly removed from, and reattached to, the body. This is due to the simple fact that it is difficult to reposition the sensor at the same attachment location each time. Since different locations on a body experience different shear-strain forces in response to an input force, different placements of a strain sensors on the body may result in different measurements of shear-strain forces in subsequent test or calibration procedures.

Similarly, it becomes difficult to calibrate and/or test the response of multiple strain sensors to an applied force simultaneously, as different placement locations about a test body may experience different responses to the applied force.

However, it has been found through a finite-element analysis, that some configurations of test bodies, such as a flat longitudinal beam, twisted about its longitudinal axis, will produce a large surface area of uniform shear-strain, such as shown in FIG. 1. The response of strain sensors attached within this uniform shear-strain region will have negligible sensitivity to their placement location on the beam. This facilitates accurate testing and calibration of the strain sensors, either simultaneously, or sequentially, as a function of the applied twisting forces (i.e., moments) on the beam, which may be measured and quantified.

Accordingly, it would be advantageous to provide an apparatus and testing procedure for evaluating and/or calibrating the response of strain sensors to determinable applied strains which are substantially insensitive to the placement location of the strain sensors within a significant region on the surface of a test body. It would further be advantageous to provide a test apparatus which may be used to achieve repeatable results, and which may be utilized in a variety of environmental conditions, such as temperatures.

Briefly stated, the present invention provides an apparatus for the testing, evaluation, and calibration of strain sensors. The apparatus is comprised of a rectilinear test beam secured at opposite ends of a longitudinal axis by clamp assemblies. A first clamp assembly at one end of the rectilinear test beam is configured to hold the rectilinear test beam in a fixed position, while the second clamp assembly at the opposite end is configured to apply a torque to the rectilinear test beam about the beam's longitudinal axis. Displacement sensors in operative proximity to the second clamp assembly provide data which is representative of the deflection of the rectilinear test beam about the longitudinal axis in response to the applied torque, while a torque sensor provides data which is representative of the actual applied torque. Output signals from one or more strain sensors disposed on the surface of the rectilinear test beam, within a region of substantially uniform shear-strain, may be calibrated in relation to the torsional deflection of the rectilinear test beam and to the applied torque.

A method of the present invention for testing and/or calibrating strain sensors initially requires identifying a region of uniform shear-strain on a rectilinear test beam, within which one or more strain sensors to be tested and/or calibrated may be secured to the rectilinear test beam. Once the strain sensors are secured to the rectilinear test beam, the rectilinear test beam is twisted about a longitudinal axis by securing one end of the beam in a fixed position while applying a torque about the longitudinal axis to the opposite end of the beam. Measurements of the physical deflection of the beam and applied torque are acquired, and utilized to evaluate and/or calibrate output signals from the strain sensors secured to the beam.

In an alternative method of the present invention, an environmental condition associated with the rectilinear test beam, such as temperature, is varied in a controlled manner to test and/or calibrate the output signals from the strain sensors secured to the beam as a function of the varied environmental condition.

The foregoing features, and advantages of the invention as well as presently preferred embodiments thereof will become more apparent from the reading of the following description in connection with the accompanying drawings.

### BRIEF DESCRIPTION OF THE DRAWINGS

In the accompanying drawings which form part of the specification:

FIG. 1 is a perspective view of a test apparatus beam, illustrating shear strain distribution over the beam surfaces;

FIG. 2A is a side view of a configured test apparatus beam;

FIG. 2B is a top plane view of a configured test apparatus beam of the embodiment shown in FIG. 2A;

FIG. 3 is a perspective view of the entire calibration and testing unit in use;

FIG. 4 is a perspective view of the beam rotating end of the calibration and testing unit of FIG. 3;

FIG. 5 is a perspective view of the beam stationary end of the calibration and testing unit of FIG. 3; and

FIG. 6 is a perspective view of strain sensors mounted to the test beam apparatus.

Corresponding reference numerals indicate corresponding parts throughout the several figures of the drawings.

### BEST MODES FOR CARRYING OUT THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

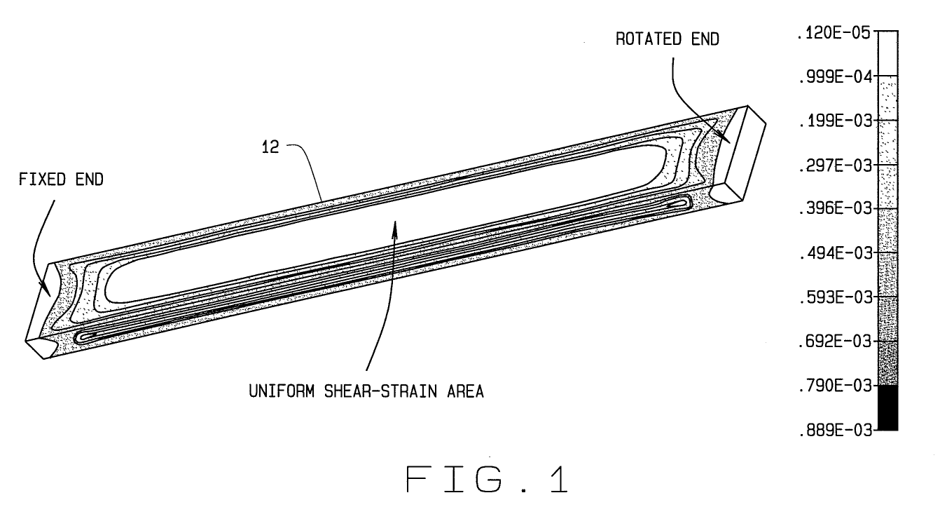

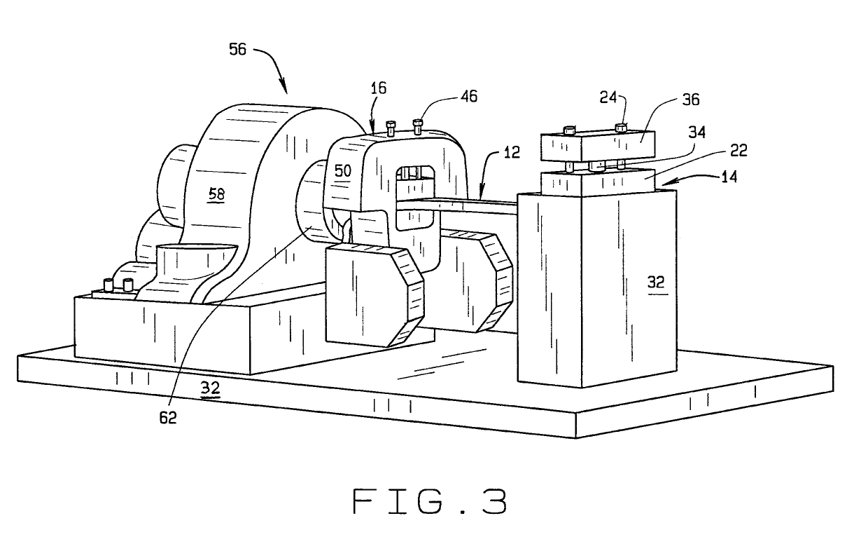

Turning to FIGS. 1-6, an embodiment of an apparatus 10 for the testing and calibration of strain sensors comprises a rectilinear test beam 12 secured at opposite ends of a longitudinal X-axis by a pair of clamp assemblies 14 and 16 (FIG. 3). The rectilinear test beam 12 as shown is in the form of a rectangular parallelepiped, but other forms and shapes having a substantially large uniform shear-strain region in response to applied torque, as shown in FIG. 1, may be utilized. Preferably, the test beam 12 is made of a material with an isotropic property, but test beams composed of materials having anisotropic properties may optionally be used.

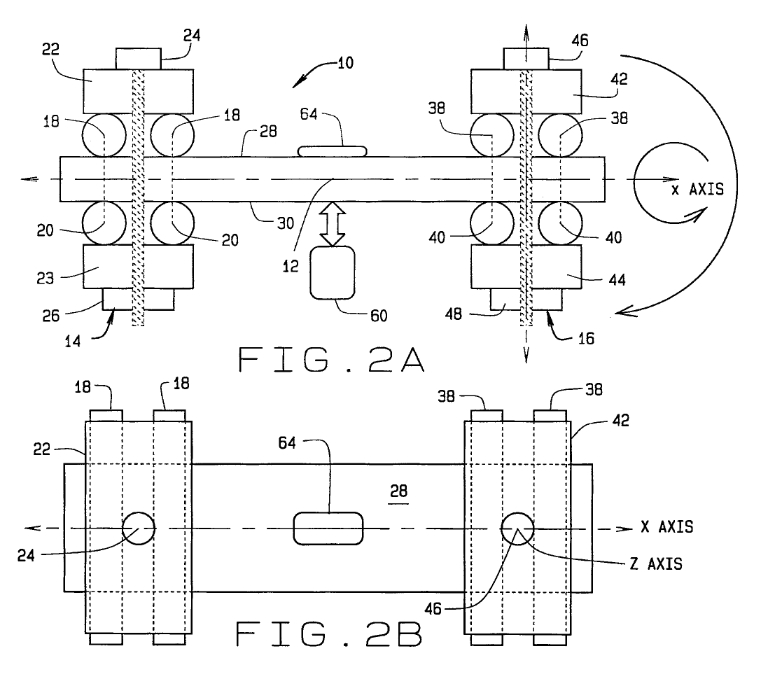

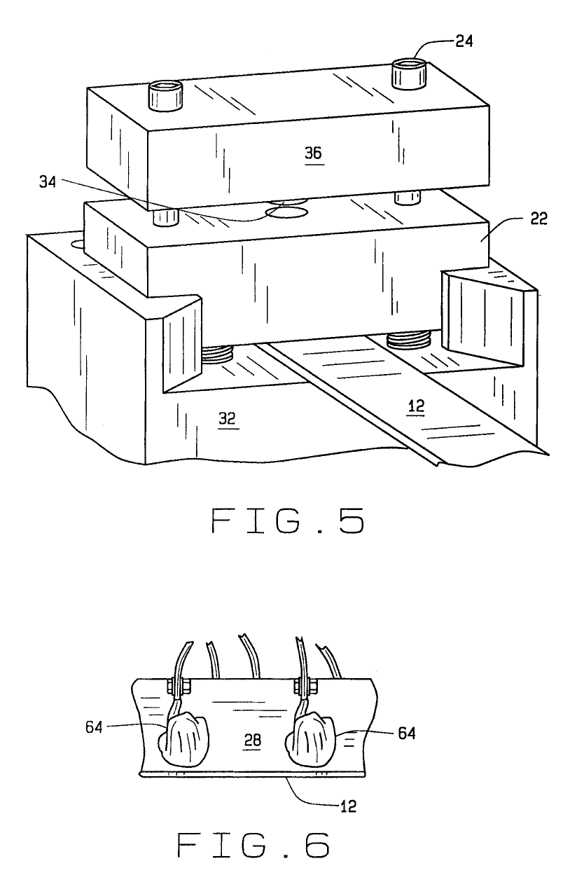

To secure the test beam 12, a first clamp assembly 14 adjacent one end of the test beam 12 consists of two pairs of cylindrical bars 18 and 20 oriented transverse to the X-axis of the test beam 12 which are secured between clamping plates 22 and 23 by one or more fasteners, such as bolts 24 and nuts 26 (FIGS. 2A-2B). One pair of cylindrical bars 18 or rods is disposed adjacent an upper surface 28 of the test beam 12, while the second pair of cylindrical bars 20 or rods is disposed adjacent a lower surface 30 of the test beam 12. The cylindrical bars 18 or rods on the upper surface 28 share lines of contact on the same plane of the X-axis as the cylindrical bars 20 or rods on the lower surface 30, as best seen in FIG. 2A. The upper clamp plate 22 is preferably removable or displaceable away from the test beam 12, facilitating placement of the beam 12 within the clamp assembly 14, while the lower clamp plate 23 is held in a fixed relationship to a stable support surface 32 (FIG. 3). With the test beam 12 disposed between the upper and lower pairs of cylindrical rods 18 and 20, the bolts 24 are tightened, exerting a clamping force on the test beam 12 through the clamp plates 22 and 23 and cylindrical rods 18 and 20. To ensure uniform distribution of clamping forces across the width of the test beam 12, a ball joint 34, shown in FIGS. 3 and 5, may be disposed between one of the clamp plates 22 and a cover plate 36 against which the bolts 24 exert the clamping force. This clamp configuration provides a repeatable and uniform clamping force against the test beam 12, holding the test beam 12 in a fixed position relative to the stable support surface 32. Alternate arrangements for securing an end of the test beam 12 in a fixed position with a uniform and repeatable clamping force may be utilized within the scope of this invention. To enhance clamping, the test beam 12 should have an appropriate roughness, preferably about 0.1 rms micron to about 10 rms micron. If the test beam 12 is too smooth, lower friction makes clamping more difficult. If the test bean 12 is too rough, the surface of the test beam will easily wear away.

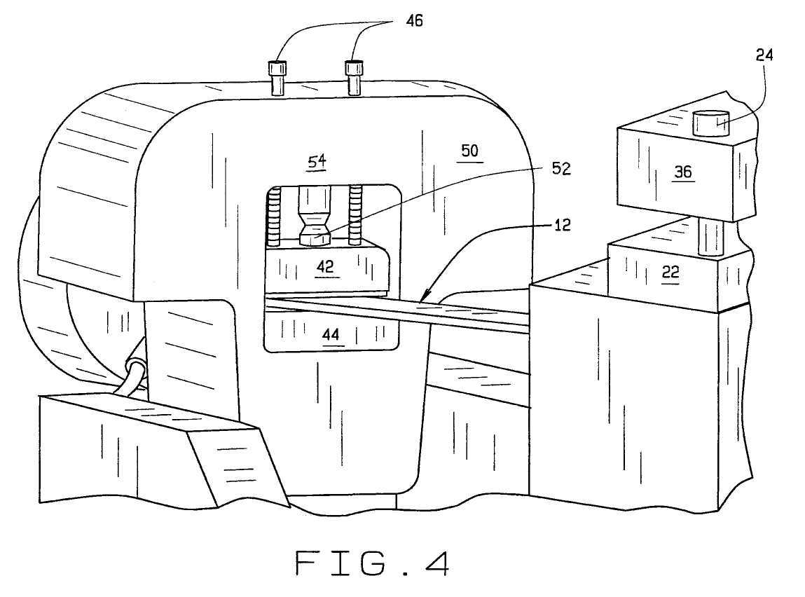

A second clamp assembly 16 at the opposite end of the test beam 12 is similar to the first clamp assembly 14 (FIGS. 2A-2B). The second clamp assembly 16, comprises two pairs of cylindrical bars 38 and 40 oriented transverse to the X-axis of the test beam 12 which are secured between clamping plates 42 and 44 by one or more fasteners, such as bolts 46 and nuts 48. One pair of cylindrical bars 38 or rods is disposed adjacent an upper surface 28 of the test beam 12, while the second pair of cylindrical bars 40 or rods is disposed adjacent a lower surface 30 of the test beam 12, as best seen in FIG. 2A. The upper clamp plate 42 is preferably removable or displaceable away from the test beam 12, facilitating placement of the beam 12 within the clamp assembly 16, while the lower clamp plate 44 is held in a fixed relationship to a clamp support frame 50 (FIG. 3). To ensure uniform distribution of clamping forces to the test beam 12, a ball joint 52, visible in FIG. 4, may be disposed between one of the clamp plates 42 and a cover plate 54 against which the bolts 46 exerts a clamping force. This clamp configuration provides a repeatable and uniform clamping force against the test beam 12, holding the test beam 12 in a fixed position relative to the clamp assembly 16. Alternate arrangements for securing an end of the test beam 12 in a fixed position with a uniform and repeatable clamping force may be utilized within the scope of this invention.

The clamp support frame 50 of the second clamp assembly 16 is coupled to a rotating assembly 56 which is configured to apply a controlled torque to the test beam 12 about the longitudinal X-axis (FIG. 3). To accommodate axial misalignments between the rotating assembly 56, which is secured in a fixed position to the stable surface 32, and the test beam's X-axis as secured by the second clamp assembly 16, the rotating assembly 56 incorporates a pillow block structure 58. While accommodating for axial misalignments, the pillow block structure 58 must also allow for torsional shrinkage along the X-axis of the test beam 12. The controlled torque may be applied manually, such as by a screw and cam arrangement, or may be automated utilizing any suitable control mechanism.

At least one displacement sensor 60 is disposed in operative proximity to the clamp support frame 50 of the second clamp assembly 16 to provide data which is representative of the deflection of the rectilinear test beam 12 about the longitudinal X-axis in response to the applied torque (FIG. 2A). Preferably one displacement sensor 60 is operatively positioned in proximity to the clamp support frame 50 on each side of the longitudinal X-axis, such that a differential combination of the sensor output signals provides a measure of rotation. The displacement sensors 60 may be any of a variety of known displacement sensors, including lasers, capacitive displacement sensors, and inductive displacement sensors.

To provide a measure of the torque applied to the test beam 12 by the rotating assembly 56, a torque sensor 62 is operatively positioned between the rotating assembly 56 and the test beam 12 to provide data which is representative of the actual applied torque to the test beam.

With the apparatus 10, one or more strain sensors 64 can be calibrated and tested by attaching them to the top and bottom surfaces 28 and 30 of the test beam 12 within the region of uniform shear-strain, preferably at 450 relative to the longitudinal axis X of the test beam 12 (FIG. 6). Any of a variety of different types of strain sensors may be tested and/or calibrated, including, but not limited to, metal-foil, semiconductor, micro-electromechanical (MEMS), capacitive, inductive, piezoresistive, optical, and surface acoustic wave (SAW) strain sensors. The strain sensors 64 can attach to the test beam 12 with any appropriate method, including, but not limited to, bonding, clamping, or bolting. Output signals from the strain sensors 64 disposed on the surfaces 28 and 30 of the test beam 12 may be calibrated in relation to the measured deflection of the test beam 12, as observed by the displacement sensors 60, and to the applied torque as measured by the torque sensor 62.

By disposing the apparatus 10 in a controlled environment, such as an oven or a refrigerator, environmental variables such as temperature can be selectively varied to provide additional data for testing and/or calibrating the output signals from the strain sensors 64 on the surfaces 28 and 30 of the test beam 12. Other environmental variables which may be controlled include, but are not limited to, pressure, humidity, electrical fields, and magnetic fields.

If no strain sensors 64 are disposed on the test beam 12, or only strain sensors 64 having negligible reaction forces are used, the measure of applied torque from the torque sensor 62 may be combined with the applied shear strain measurements (derived from the displacement measurements) to provide an estimate of the shear modulus of the test beam 12 itself.

In another embodiment, a reference strain gage can be attached to the test beam 12 in the uniform shear-strain region to provide data regarding shear strain measurements for calibrating the strain gages 64. The reference strain gage can be used independently or in conjunction with the displacement sensors 60 and torque sensors 62 for calibrating the strain gages 64.

A method for testing and/or calibrating strain sensors 64 initially requires identifying a region of uniform shear-strain on a test beam 12, within which one or more strain sensors 64 to be tested and/or calibrated may be secured. Once the strain sensors 64 are secured to the rectilinear test beam 12, the rectilinear test beam 12 is twisted about a longitudinal axis by securing one end of the test beam 12 in a fixed position while applying a torque about the longitudinal axis to the opposite end of the test beam 12. Measurements of the physical deflection of the test beam 12 about the longitudinal X-axis and the applied torque are acquired and utilized to test and/or calibrate output signals from the various strain sensors 64 secured to the beam.

In an alternate method of the present invention, an environmental condition associated with the test beam 12, such as temperature, is varied in a controlled manner between test cycles to test and/or calibrate the output signals from the strain sensors 64 secured to the beam 12 as a function of the varied environmental condition. This can be accomplished by heating and cooling the entire apparatus 10 or by heating and cooling the test beam 12 and strain gages 64 locally, such as with an environmental chamber surrounding the test beam 12 and strain gages 64. More specifically, the test beam 12 and strain gages 64 can be heated locally transmitting an electric current through the test beam 12 or by inductive heating.

The test beam 12 can be used in conjunction with four-point bending calibration/testing systems to measure cross-coupling errors.

Changes can be made in the above constructions without departing from the scope of the invention, it is intended that all matter contained in the above description or shown in the accompanying drawings shall be interpreted as illustrative and not in a limiting sense.

1. A method for calibrating the output of at least one strain sensor, comprising:
providing a first clamp;
providing a second clamp;
providing a rotating assembly attached to the second clamp and having a pillow block assembly;
disposing each of said strain sensors on a test beam within a region of substantially uniform shear-strain;
securing one end of said test beam in a fixed position with the first clamp;
securing a second end of said test beam with said second clamp;
applying a torque about a longitudinal axis of said test beam at said second end, said second end opposite from said first end, with said rotating assembly;
positioning a sensor on said test beam to measure at least two parameters of said test beam without repositioning said strain sensors, said parameters selected from a set of parameters including a displacement of said test beam about said longitudinal axis and said applied torque, wherein said pillow block assembly is configured to accommodate shrinkage along the longitudinal axis of said test beam due to the applied torsion;
acquiring an associated output signal from each of said strain sensors; and
calibrating each of said associated output signals with at least one of said measured displacement and said measured torque.

2. The method of claim 1 wherein said step of measuring includes measuring said displacement of said test beam about said longitudinal axis and said applied torque; and
further including the step of determining a shear modulus of said test beam.

3. The method of claim 1 further including measuring at least one environmental variable in proximity to the test beam; and
calibrating said associated output signals with said measured environmental variable.

4. The method of claim 3 wherein said environmental variable is temperature.

5. An apparatus for testing and/or calibrating the output of at least one strain sensor, comprising:
a first clamp assembly secured to a fixed surface, said first clamp assembly configured to apply a uniform clamping force;
a second clamp assembly secured to a rotating assembly displaced from said first clamp assembly, said second clamp assembly configured to apply a uniform clamping force;
a test beam secured at opposite ends by said first and second clamp assemblies, said test beam having a longitudinal axis and a region of uniform shear-strain within which the at least one strain sensor may be operatively secured to acquire a measurement of strain;
wherein said rotating assembly is configured to apply a torque to said test beam about said longitudinal axis through said second clamp assembly; and
at least one sensor operatively positioned to measure a parameter associated with said test beam, said parameter selected from a set of parameters including a rotational displacement and an applied torque.

6. The apparatus of claim 5 wherein said sensor includes at least one displacement sensor operatively positioned to measure rotational displacement of the second clamp assembly about said longitudinal axis.

7. The apparatus of claim 5 wherein said sensor is a torque sensor operatively positioned to measure said applied torque.

8. The apparatus of claim 5 wherein at least one strain sensor is selected from a set of strain sensor types including metal-foil, semiconductor, micro-electromechanical (MEMS), capacitive, inductive, piezoresistive, optical, and surface acoustic wave (SAW) strain sensors.

9. The apparatus of claim 5 further including a means to selectively control at least one environmental variable in proximity to said test beam.

10. The apparatus of claim 9 wherein said environmental variable is temperature.

11. The apparatus of claim 5 wherein said first clamp assembly secured to said fixed surface includes a lower clamp plate, a lower pair of transverse clamping cylindrical rods, an upper pair of transverse clamping cylindrical rods, an upper clamp plate, and at least one bolt securing said upper and lower clamping cylindrical rods between said upper and lower clamp plates; whereby an end of said test beam is clamped across said longitudinal axis between said upper and lower transverse clamping cylindrical rods.

12. The apparatus of claim 11 wherein said first clamp assembly further includes at least one ball joint configured to uniformly distribute clamping forces.

13. The apparatus of claim 5 wherein said second clamp assembly secured to said rotating assembly includes a lower clamp plate, a lower pair of transverse clamping cylindrical rods, an upper pair of transverse clamping cylindrical rods, an upper clamp plate, and at least one bolt securing said upper and lower clamping cylindrical rods between said upper and lower clamp plates; whereby an end of said test beam is clamped across said longitudinal axis between said upper and lower transverse clamping cylindrical rods.

14. The apparatus of claim 13 wherein said second clamp assembly further includes at least one ball joint configured to uniformly distribute clamping forces.

15. The apparatus of claim 5 wherein said rotating assembly includes a pillow block component to accommodate axial misalignment between said rotating assembly and said longitudinal axis of said test beam.

16. The apparatus of claim 15 wherein said pillow block component is configured to accommodate shrinkage along said longitudinal axis of the said test beam due to the applied torsion.

17. The apparatus of claim 5 wherein said test beam is composed of material having isotropic properties.

18. The apparatus of claim 5 wherein said test beam is composed of material having anisotropic properties.

19. The apparatus of claim 5 wherein said displacement sensors are selected from a set of displacement sensor types including laser, capacitive, and inductive displacement sensors.

20. A method for measuring a shear modulus of a test beam, comprising:
disposing strain sensors having negligible reaction forces on the test beam within a region of substantially uniform shear-strain;
securing one end of said test beam in a fixed position;
applying a torque about a longitudinal axis of said test beam at a second end, said second end opposite from said first end;
measuring a displacement of said test beam about said longitudinal axis;
measuring said applied torque; and
determining a shear modulus of the test beam from said measured displacement and said measured torque.
